(19) United States
(12) Patent Application Publication
(10) Pub. No.: US 2001/0041546 A1
(43) Pub. Date: Nov. 15, 2001

(54) Direct-conversion modulation with reduced local oscillator leakage

(76) Inventor: Leonid Kazakevich, Plainview, NY (US)

Correspondence Address: VOLPE AND KOENIG, PC, DEPT ICC, SUITE 400, ONE PENN CENTER, 1617 JOHN F. KENNEDY BOULEVARD, PHILADELPHIA, PA, 19103, US

(21) Appl. No.: 09/774,916

(22) Filed: Jan. 31, 2001

Related U.S. Application Data
(60) Provisional application No. 60/179,861, filed on Feb. 2, 2000.

(51) Int. Cl. H04B 1/04; H01Q 11/12

(52) U.S. Cl. 455/118; 455/313; 455/333; 375/298

(57) ABSTRACT

For direct up- or down-conversion between baseband and carrier frequency signals, each component of such a signal is supplied to a first mixer together with a local oscillator signal at one-half the carrier frequency and the output from that first mixer is supplied to a second mixer together with the same local oscillator signal, but at a phase which differs by 90° from that of the local oscillator signal supplied to the first mixer.

### BACKGROUND

### DESCRIPTION OF THE RELATED ART

Frequency up and down conversion is essential for many types of radio transmissions regardless of the communication media employed. Conversion is the process of up-converting baseband data signals, whether analog or digital, to a higher frequency for transmission, or down-converting a radio frequency transmission to a baseband frequency for signal processing. The conversion process typically requires at least one local oscillator, (or LO), and a mixer to either up-or down-convert. Various prior art mixer types include unbalanced, single and double balanced types and four quadrant so-called “Gilbert cell” mixers. The use of multiple conversion stages or mixers is commonplace. The use of a single mixing stage for conversion is also known and is referred to as “direct-conversion”. Direct-conversion eliminates multiple intermediate-frequency or IF stages and their associated filters.

One potential disadvantage of direct conversion is rf leakage. If a LO mixing frequency is equal to the data signal frequency, and if there are inadequate band pass filters providing radiation suppression, the LO signal can distort a received signal, or, alternatively leak and radiate from a transmission antenna and thereby become a jamming signal for other users. For the case where LO leakage has manifested itself in transmitters employing direct-conversion modulation (up-conversion), the leakage can be in-band (in-channel) thereby jamming the desired transmitted signal and also directly affecting the control of effective transmitted power.

One known technique for ameliorating the above effects when using direct conversion techniques is to use sub-harmonic mixers. A sub-harmonic mixer relies on a LO frequency that is a fraction of the in-coming signal frequency. However, sub-harmonic mixers are difficult to implement since they use application-specific integrated circuits and therefore require non-standard, custom cells.

### SUMMARY OF THE INVENTION

The present invention utilizes for direct frequency conversion not only a single mixer, but rather a pair of mixers connected in series. These can be standard cells, rather than the non-standard custom cell of the prior art. The first mixer of the pair is supplied with the signal which is to be direct-converted (either up-or-down) and also with a signal at one-half the higher of the two frequencies between which the conversion is taking place (in practice the “higher frequency” is normally the rf carrier frequency). The second mixer of the pair is supplied with the output signal from the first mixer and with a signal at the same one-half of the higher (carrier) frequency as the first mixer, but in phase quadrature with that one-half frequency signal supplied to the first mixer.

The output signal from the second mixer of the pair then constitutes the desired direct up-or-down-converted signal.

The invention can also be extended to the direct-conversion of signals which have multiple components, such as the in-phase (I) and quadrature (Q) components of a QPSK (Quadrature Phase Shift Key) system. In such a system, each component (I and Q) is subjected to processing by a separate pair of series-connected mixers. The first mixer of each pair is supplied with the respective signal component and with a signal at one-half the higher frequency involved in the conversion. The second mixer of that same pair is supplied with the output of the first mixer and with a signal at the same one-half frequency as is supplied to the first mixer, but again in phase quadrature with respect to the same one-half frequency signal supplied to the first mixer of that pair. Moreover, the one-half frequency signal supplied to the first mixer of the pair which processes one of said components has a phase which is half-way between the (quadrature) phases of one of the two one-half frequency signals supplied to the mixers of the pair which processes the other of said components.

As will be shown, the above provides an efficient direct-conversion system and method which eliminates LO leakage and allows economic implementation as an integrated circuit (IC). The invention allows for low power and low cost IC construction having a smaller die size with no required tuning. Since the invention inherently prevents LO leakage by providing inherent suppression of undesired components, it requires fewer external support components. It also allows for linear Automatic Gain Control (AGC) while exhibiting a uniform transmission spectrum.

For further details, reference is made to the discussion which follows in light of the accompanying drawings.

### BRIEF DESCRIPTION OF THE DRAWINGS

FIG. 1 is a system block diagram of an embodiment of the present invention.

FIG. 2 is a system block diagram of the present invention implemented for the direct down-conversion of a QPSK signal.

FIG. 3 is a system block diagram of the present invention implemented for the direct up-conversion of a QPSK signal.

### DETAILED DESCRIPTION OF THE PREFERRED EMBODIMENTS

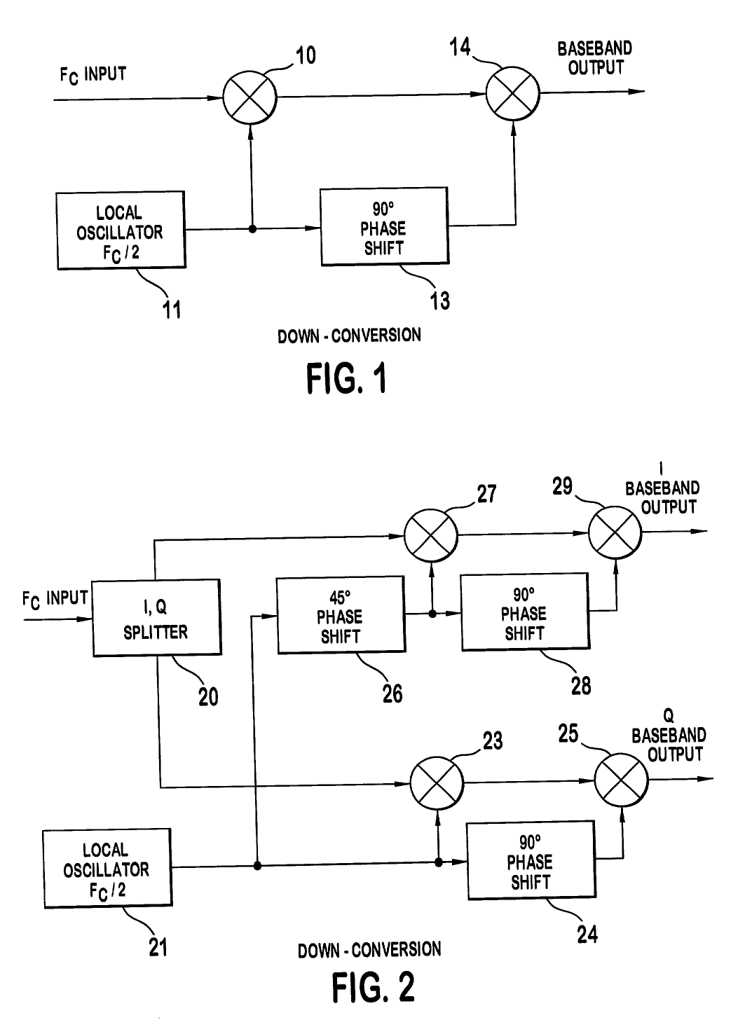

Referring to FIG. 1, this shows a down-conversion embodiment of the invention, starting with a modulated carrier signal of nominal frequency F_{C}. This signal is supplied to a first mixer 10, which is also supplied with a signal from a local oscillator 11. Oscillator 11 outputs a signal at one-half the nominal carrier frequency F_{C}. The phase of this ½ F_{C}oscillator 11 output is in a predetermined relationship to the phase of the carrier at F_{C}. Preferably, this relationship between phases is that of sine-to-sine (at their respective frequencies). The signal at ½ F_{C}so outputted by oscillator 11 is subjected to a 90° phase shift in phase shifting circuit 13 and is then supplied to mixer 14, where it is combined with the output signal from mixer 10.

As demonstrated below, the baseband output signal from mixer 14 is free of second harmonic components.

Let the input signal S having a carrier frequency F_{C} be represented by equation (1) below:

$$S = A sin ( {ω}_{1} t + Ω t ) \qquad ( 1 )$$

A is the amplitude of the signal S, ω,t is its carrier component and Ω is its data component. The local oscillator 11 outputs a signal LO₁ at one-half the carrier frequency F_{C}. The output signal LO₁ can then be represented by equation (2) below:

$${L0}_{1} = L sin ( \frac{{ω}_{1} t}{2} ) \qquad ( 2 )$$

The resultant output M₁ from mixer 10 can be represented by equation (3) and (3′) below where L is the amplitude of the local oscillator output signal:

$$\begin{matrix}{M}_{1} = {L0}_{1} ( S ) & ( 3 ) \\ = A sin ( {ω}_{1} t + Ω t ) ( L sin ( \frac{{ω}_{1} t}{2} ) ) & ( {3}^{′} )\end{matrix}$$

The output M₁ from mixer 10 is supplied to second mixer 14 where it is mixed with another output LO₂ from local oscillator 11. This other oscillator output has previously been phase shifted by 90° in phase shift circuit 13. The so-phase shifted output LO₂ can be represented by the equation (4) below:

$${LO}_{2} = L cos ( \frac{{ω}_{1} t}{2} ) \qquad ( 4 )$$

The output M₂ from the second mixer 14 can then be represented by the equation (5), (5′), (5″) and (5″′) below:

M₂=L₂(LO₁)S (5)

$$\begin{matrix}{M}_{2} = {L0}_{1} ( {L0}_{1} ) S & ( 5 ) \\ = A sin ( {ω}_{1} t + Ω t ) ( L sin ( \frac{{ω}_{1} t}{2} ) ) L cos ( \frac{{ω}_{1} t}{2} ) & ( {5}^{′} ) \\ = A sin ( {ω}_{1} t + Ω t ) 0.5 {L}^{2} sin ( {ω}_{1} t ) & ( {5}^{″} ) \\ = ( 0.25 {AL}^{2} ) ( - cos ( 2 {ω}_{1} t + Ω t ) + cos ( Ω t ) ) & ( {5}^{″′} )\end{matrix}$$

Further, the baseband portion bb of this output signal M₂ is shown by equation (6) and (6′) below:

bb=(0.25AL²)cos(Ωt) (6)

=C Cos(Ωt) (6′)

Note the absence of a second harmonic term ω₁t in the baseband portion of the output from the embodiment of FIG. 1.

Turning to FIG. 2, this is an embodiment in which the invention is applied for direct down-conversion in a system in which data are conveyed as I and Q components modulated on the same carrier frequency F_{C}. Those components are first separated in a conventional I/Q signal splitter 20. One of these components, say the Q component, is then processed in the same manner as described for the whole signal with reference to FIG. 1 above.

This involves a local oscillator 21 which produces a signal at frequency ½ F_{C}. The I component and the output signal from oscillator 21 are supplied to a first mixer 23, which operates in a similar manner to mixer 10 in FIG. 1. The signal from oscillator 21 is shifted by 90° in phase shift circuit 24, as is done by phase shift circuit 13 in FIG. 1 and is then mixed in mixer 25 with the output signal from mixer 23.

The result is that the Q component is reduced to baseband, with no second harmonics appearing in this Q baseband output.

Essentially the same processing is performed on the I component from splitter 20, except that the local oscillator signals used for that purpose are further phase shifted by 45° from those which are used to process the Q component, as described above. Specifically, the signal at frequency ½ F_{C} from local oscillator 21 is first shifted in phase by 45° in phase shifter 26 and is then supplied to mixer 27, together with the I component at frequency F_{C} from splitter 20.

The same local oscillator signal is further shifted in phase by 90° in phase shifter 28 and then applied to mixer 29. The result is that the I component is also reduced to baseband, with no second harmonic component in that baseband output. The two I and Q baseband outputs may then be processed further in any conventional manner (not shown).

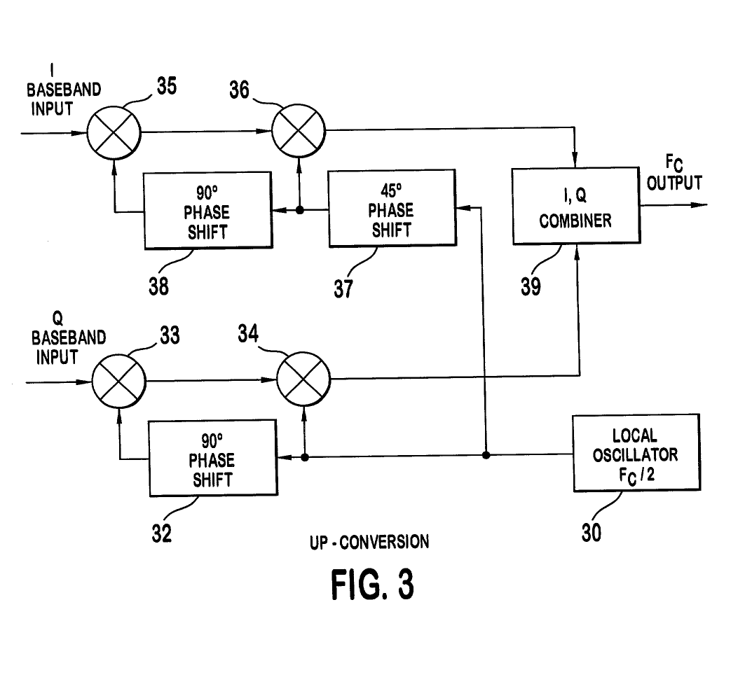

Turning to FIG. 3, this shows the application of the invention to up-conversion (from baseband to high frequency) of I and Q signal components. As appears from the drawing, these are processed in a manner which is similar to that of FIG. 2, but in what might be called the inverse sequence.

A local oscillator 30 is phase shifted by 90° in circuit 32 and then mixed with the baseband Q component in mixer 33. The output of that mixer 33 is further mixed in mixer 34 with the local oscillator signal, but without having been subject to the 90° phase shift in circuit 32. The result is that the output from mixer 34 constitutes the up-converted Q signal.

As for the baseband I signal, this is mixed first in mixer 35, with a signal from local oscillator 30 which has been shifted by 45° in phase shifter 37 and then by 90° in phase shifter 38. The output from mixer 35 is mixed with the same local oscillator signal which has been shifted by 45° in phase shifter 37, but has not been further subjected to phase shifter 38. The result is that the output from mixer 36 constitutes the up-converted I signal.

The output signals from mixers 34 and 37 may then be processed further in any manner that is conventional for this purpose.

In the systems of both FIGS. 2 and 3, the relative phases of the local oscillator signals supplied to the respective mixers should be shown and described herein, namely 0°, 45°, 90°, and 135°, respectively. On the other hand, the phase of each individual supplied local oscillator signal can be adjusted as described, provided only that the above-stated relative phases are maintained.

It will also be understood that the invention can be extended to the direct conversion of signals with more than two signal components, by providing additional pairs of mixers for the additional components. For each such pair, the respective local oscillator signals must be supplied with a 90° phase difference from each other; the absolute phase of one of the local oscillator signals supplied to one pair of mixers is preferably equidistant from the absolute phase of one of the local oscillator signals supplied to one of every other pair of mixers.

Other modifications will occur to those skilled in the art without departing from the inventive concept, which is therefore defined only by the scope of the appended claims.

What is claimed is:

1. A system for direct frequency conversion between baseband data signals and carrier frequency signals modulated with said baseband data signals, said system comprising:
first and second mixers;
means for supplying to one of said mixers the signals to be converted and a signal at one-half of said carrier frequency;
means for supplying to the other of said mixers the output signal from said first mixer and said signal at one-half said carrier frequency, but with a phase which is in quadrature with said one-half frequency signal supplied to said first mixer; and
said carrier frequency signals and said signals at one-half said carrier frequency being maintained in a predetermined phase relationship.

2. The system of claim 1 wherein both said signals at said one-half carrier frequency are unmodulated with said baseband data signals when supplied to said mixers.

3. The system of claim 1 wherein both said signals at said one-half frequency are derived from the same source.

4. The system of claim 1 wherein the data signals supplied to said one mixer are at baseband.

5. The system of claim 1 wherein said data signals supplied to said one mixer are at said carrier frequency.

6. The system of claim 5 wherein said carrier frequency signals are at radio frequency.

7. The system of claim 1 wherein said baseband data signals include in-phase and quadrature phase components.

8. The system of claim 1 wherein said carrier frequency signals include in-phase and quadrature components.

9. The system of claim 7 wherein the baseband signal supplied to said first mixer is one of the in-phase or quadrature phase components of the baseband data signals;
said system further comprising third and fourth mixers, and means for supplying said third and fourth mixers, respectively, with signals at one-half said carrier frequency, in mutual phase quadrature, and also equally displaced in phase from the one-half carrier frequency signals supplied to said first and second mixers; and
said third mixer being also supplied with the quadrature phase component of said baseband signals and the fourth mixer being supplied with the output from said third mixer.

10. The system of claim 1, wherein the one-half carrier frequency signals supplied to said first mixer are maintained in-phase with said carrier frequency signals.

11. The system of claim 3, wherein the one-half carrier frequency signals supplied to said third and fourth mixers are maintained in a relationship of 45° and 135°, respectively, to the phase of the carrier frequency signals.
